(19) United States
(12) Patent Application Publication
(10) Pub. No.: US 2009/0046696 A1
(43) Pub. Date: Feb. 19, 2009

(54) DTMF SIGNALING IN WIRELESS COMMUNICATIONS NETWORKS

(76) Inventor: Jianxiong Shi, Pleasanton, CA (US)

Correspondence Address: KACVINSKY LLC;4500 BROOKTREE ROAD, SUITE 102, WEXFORD, PA, 15090, US

(21) Appl. No.: 11/837,643

(22) Filed: Aug. 13, 2007

(51) Int. Cl. H04J 3/00

(52) U.S. Cl. 370/347; 370/345

(57) ABSTRACT

Techniques for transmitting DTMF symbols in wireless communications networks are disclosed. For instance, an apparatus may include a dual-tone multi-frequency (DTMF) messaging module and a transceiver. The DTMF messaging module generates a layer 3 (L3) DTMF message that represents two or more DTMF digits. The transceiver sends the DTMF message across a wireless communications network, such as a GSM network or a UMTS network. In addition, the transceiver receives, from the wireless communications network, an acknowledgment of the DTMF message. This acknowledgment is a DTMF-specific L3 signaling message.

### BACKGROUND

Mobile computing devices, such as smart phones, may provide various processing capabilities. For example, mobile devices may provide personal digital assistant (PDA) features, including word processing, spreadsheets, synchronization of information (e.g., e-mail) with a desktop computer, and so forth.

In addition, such devices may have wireless communications capabilities. More particularly, mobile devices may employ various communications technologies to provide features, such as mobile telephony, mobile e-mail access, web browsing, and content (e.g., video and radio) reception. Exemplary wireless communications technologies include cellular, satellite, and mobile data networking technologies.

Dual-tone multi-frequency (DTMF) signaling is used in conventional telephony networks for dialing, as well as for the in-band transmission of information once a call is established. Typically, wireless (e.g., cellular) networks do not use DTMF for dialing. However, DTMF may be needed for certain wireless calls such as ones with devices on traditional wired telephony networks. For instance, calls to businesses and other organizations often involve automated menus that request caller selections through DTMF signals.

Typically, in cellular networks, DTMF signals are not suitable for in-band transmission. This is because distortions caused by audio encoding schemes can make the recognition of DTMF digits in received transmissions difficult. Thus, cellular networks employ separate signaling messages between mobile stations and network entities to convey DTMF digits.

Unlike other networks (such as cdma2000 systems which employ messages that convey multiple DTMF digits), Global System for Mobile communications (GSM) networks and Universal Mobile Telecommunications System (UMTS) networks generate a separate set of messages for each DTMF digit. This may cause undesirable delays in the transfer of multiple DTMF digits across these networks.

### BRIEF DESCRIPTION OF THE DRAWINGS

FIG. 1 illustrates an embodiment of an apparatus.

FIG. 2 illustrates an exemplary implementation embodiment.

FIGS. 3A and 3B are diagrams showing exemplary message exchanges.

FIG. 4 is an exemplary flow diagram.

FIG. 5 illustrates an embodiment of a system.

### DETAILED DESCRIPTION

Various embodiments may be generally directed to techniques for DTMF symbols in wireless communications networks. For instance, an apparatus may include a dual-tone multi-frequency (DTMF) messaging module and a transceiver. The DTMF messaging module generates a DTMF message that represents one or more DTMF digits. The transceiver sends the DTMF message across a wireless communications network, such as a GSM network or a UMTS network. In addition, the transceiver receives, from the wireless communications network, an acknowledgment of the DTMF message. This acknowledgment is a DTMF-specific signaling message.

Various advantages may be obtained through such techniques. For instance, DTMF signaling may be more efficient and take less time.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment” or “in an embodiment” in various places in the specification are not necessarily all referring to the same embodiment.

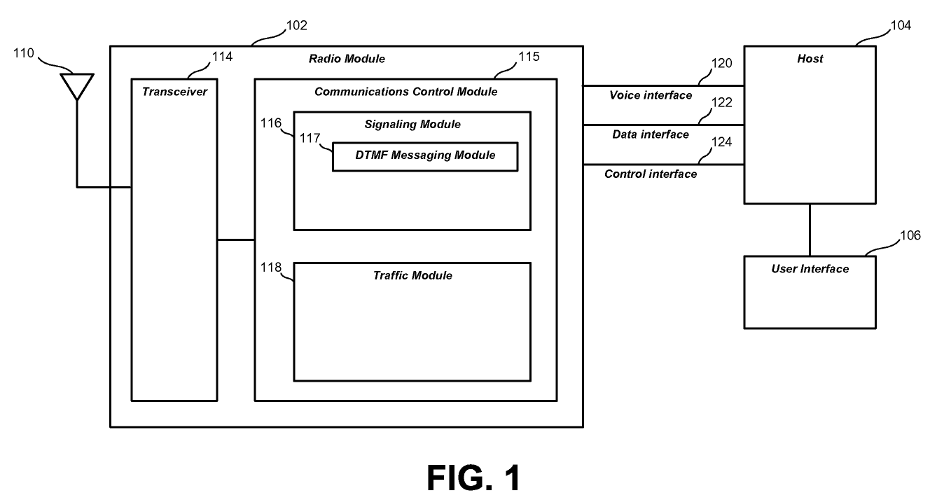

FIG. 1 illustrates an embodiment of an apparatus that may engage in cellular communications across GSM networks (which are time division multiple access (TDMA) networks) and/or UMTS networks. In particular, FIG. 1 shows an apparatus 100 comprising various elements. The embodiments, however, are not limited to these depicted elements. FIG. 1 shows that apparatus 100 may include a radio module 102, a host 104, and a user interface 106. These elements may be implemented in hardware, software, firmware, or in any combination thereof.

Radio module 102 may communicate (through an antenna 110) with remote devices (such as cellular base stations) across various types of wireless links. For example, radio module 102 may communicate across Global System for Mobile communications (GSM) networks or Universal Mobile Telecommunications System (UMTS) networks.

FIG. 1 shows that radio module 102 includes a transceiver 114 and a communications control module 115. Transceiver 114 may include a transmitter and a receiver to send and receive wireless transmissions. To provide these features, transceiver 114 may include electronics, such as modulators, amplifiers, filters, mixers, diplexers, and so forth. The embodiments, however, are not limited to such electronics.

The wireless transmissions sent and received by transceiver 114 comprise signals that may be modulated according to various schemes and may be transmitted at various frequencies. Accordingly, transceiver 114 may include a modem to perform modulation and demodulation operations associated with such signals. Also, transceiver 114 may include timing functionality to operate in accordance with network timing constructs, such as time division multiple access (TDMA) frames.

Communications control module 115 may perform various operations. For example, communications control module 115 may determine when transceiver 114 may transmit and/or receive signals. Also, communications control module 115 may perform operations involving handoffs between cells. Examples of such operations include the evaluation of potential handoff candidates or cells. Such evaluations may be based on one or more power measurements that communication control module 115 receives from transceiver 114.

FIG. 1 shows that communications control module 115 includes a traffic module 118 and a signaling module 116. These elements may be implemented in hardware, software, firmware, or any combination thereof.

Traffic module 118 handles payload traffic (e.g., voice and data) exchanged across wireless networks by transceiver 114. For instance, traffic module 118 may perform operations, such as the buffering of information. Such buffered information may be for wireless transmission by transceiver 114. Also, such buffered information may be information that transceiver 114 receives from remote devices.

Signaling module 116 generates and processes signaling messages exchanged across wireless networks by transceiver 114. Accordingly, signaling module 116 may provide transceiver 114 with signaling messages for wireless transmission to remote devices (e.g., base stations), and obtain signaling messages received wirelessly by transceiver 114 from such remote devices. Examples of such signaling messages include DTMF messages, dialing messages, and so forth.

As shown in FIG. 1, signaling module 116 includes a DTMF messaging module 117, which generates and processes DTMF messages. More particularly, DTMF messaging module 117 receives indications of DTMF digits from host 104 and generates corresponding DTMF signaling messages for wireless transmission by transceiver 114. Also, DTMF messaging module 117 obtains and processes DTMF signaling messages (e.g., acknowledgment messages) that transceiver 114 receives from remote devices, such as base stations.

Host 104 may perform operations associated with user applications. Exemplary user applications include telephony, text messaging, e-mail, web browsing, word processing, and so forth. Furthermore, host 104 may perform operations associated with one or more protocols (e.g., multiple protocols at various layers). Moreover, host 104 may provide one or more functional utilities that are available to various protocols, operations, and/or applications. Exemplary utilities include operating systems, device drivers, user interface functionality, and so forth.

As shown in FIG. 1, various interfaces are provided for the exchange of information between host 104 and radio module 102. As shown in FIG. 1, these interfaces include a voice interface 120, a data interface 122, and a control interface 124.

Voice interface 120 provides for the exchange of audio (e.g., voice) signals. These signals may be associated with telephony applications. In embodiments, such signals may be in a digital or analog format. For instance, such signals may be pulse-amplitude modulated (PAM) signals, or digital pulse-code modulated signals. However, the embodiments are not limited to these examples.

Data interface 122 provides for the exchange of data associated with various applications. For instance, such data may be associated with Internet Protocol (IP) communications (e.g., web browsing, e-mail and so forth), as well as other types of data communications (e.g., short message service (SMS) messages, multimedia messaging service (MMS) messages, and so forth).

Control interface 124 provides for the exchange of control data associated with various applications. Also, control interface 124 may provide for the exchange of information that establishes or modifies various operational parameters of host 104 and/or radio module 102.

Interfaces 120, 122, and 124 may be implemented in various ways. For instance, these interfaces may be implemented with one or more bus interfaces, one or more Universal Serial Bus (USB) interfaces, one or more universal asynchronous receiver/transmitter (UART) interfaces, as well as other types of interfaces (e.g., other types of serial and/or parallel interfaces). Thus, while shown as being distinct, interfaces 120, 122, and/or 124 may be logical or virtual interfaces that share common communications media. Also, interfaces 120, 122, and/or 124 may be implemented with shared memory. Further, these interfaces may include non-physical aspects. For instance, these interfaces may be implemented through messages passed between processes or software modules. The embodiments, however, are not limited to these examples.

As shown in FIG. 1, user interface 106 is coupled to host 104. This coupling may be through with one or more interfaces (e.g., bus, serial, and/or parallel interfaces). Additionally or alternatively, this coupling may be provided through other techniques, such as shared memory, messages passed between processes or software modules, and so forth. The embodiments, however, are not limited to these examples.

User interface 106 facilitates user interaction with apparatus 100. This interaction may involve the input of information from a user and/or the output of information to a user. Accordingly, user interface 106 may include one or more devices, such as a keyboard (e.g., a full QWERTY keyboard), a keypad, a touch screen, a microphone, and/or an audio speaker.

Thus, through user interface 106, a user may engage in voice conversations. that involve the exchange of audio (e.g., voice) signals. Also, during such conversation, a user enter data (e.g., DTMF digits) for transmission across wireless networks. Entry of DTMF digits may involve a user pressing keys on a keypad. The embodiments, however, are not limited to this form of user input.

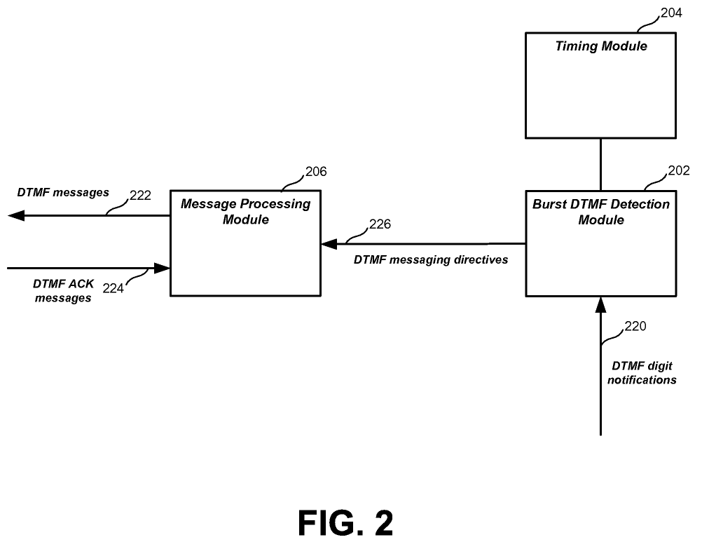

As described herein, embodiments may combine multiple DTMF symbols or digits in a single network message. Thus, DTMF messaging module 117 may wait according to certain timing parameters before providing a DTMF signaling message to transceiver 114 for wireless transmission. Details regarding an exemplary implementation of DTMF messaging module 117 are provided below with reference to FIG. 2.

As described above, the elements of FIG. 1 may be implemented in hardware, software, firmware, or any combination thereof. Thus, implementations may include one or more processors that execute instructions or control logic stored in a storage medium (e.g., memory). Such storage media may further be included in apparatus 100. In exemplary implementations, one or more processors may be associated with host 104, and one or more processors may be associated with radio module 102. The embodiments, however, are not limited to such implementations.

FIG. 1 provides an exemplary apparatus arrangement. However, the embodiments are not limited to this arrangement. For instance, embodiments may include further radio modules that may employ various types of wireless networks. Examples of such wireless networks include wireless local area networks (WLANs), wireless metropolitan area networks (WMANs), and personal area networks (PANs).

FIG. 2 is a diagram of an implementation 200 that may be employed, for example, in apparatus 100 of FIG. 1. Implementation 200 may include various elements. For instance, FIG. 2 shows implementation 200 including a burst DTMF detection module 202, a timing module 204, and a message processing module 206. These elements may be implemented in hardware, software, firmware, or any combination thereof.

The elements of FIG. 2 may be arranged in arranged in various ways. For example, in the context of FIG. 1, burst DTMF detection module 202 and timing module 204 may be implemented in host 104, while message processing module 206 may be included in DTMF signaling module 117. Alternatively, each of the elements shown in FIG. 2 may be implemented in DTMF messaging module 117. As a further alternative, each of the elements shown in FIG. 2 may be implemented in host 104. The embodiments, however, are not limited to these exemplary arrangements.

Burst DTMF detection module 202 receives DTMF digit notifications 220. With reference to FIG. 1, these notifications may be received from user interface 106 (e.g., directly or through one or more components or modules of host 104). Each of these notifications may indicate various aspects of an entered DTMF digit, such as its value, its start time, and its stop time. Accordingly, DTMF digit notifications 220 may be in the form of digital signals or data messages. However, in embodiments, DTMF digit notifications 220 may be implemented as actual analog DTMF signals.

Upon the receipt of notifications 220, burst DTMF detection module 202 may generate one or more DTMF messaging directives 226. As shown in FIG. 2, these messaging directives are sent to message processing module 206. Referring again to FIG. 1, directives 226 may be sent across control interface 124 (e.g., when modules 202 and 204 are included in host 104, and module 206 is included in DTMF messaging module 11 7). The embodiments, however, are not limited to this implementation.

Each DTMF messaging directive 226 may indicate one or more DTMF digits to be conveyed in a signaling message across a wireless link. The digit(s) included in a particular DTMF messaging directive 226 may be based on the arrival times of such digit(s). Thus, burst DTMF detection module 202 may employ timing module 204 in generating DTMF messaging directives 226.

For instance, burst DTMF detection module 202 may engage timing module 204 to determine when certain time periods have elapsed. For example, burst DTMF detection module 202 may generate a single DTMF messaging directive 226 for all DTMF digit notifications 220 that are received within a predetermined time interval. Alternatively, DTMF message processing module 206 may generate a single DTMF messaging directive 226 for a sequence of DTMF digit notifications 220 in which the elapsed times between all pairings of consecutive DTMF notifications 220 in the sequence are less than a predetermined time interval. The embodiments, however, are not limited to such timing implementations.

As described above, message processing module 206 receives DTMF messaging directives 226 from burst DTMF detection module 202. Upon receipt of these directives, message processing module 206 generates corresponding DTMF signaling messages 222. Thus, each DTMF signaling message 222 includes the DTMF digit(s) indicated in its corresponding DTMF message directive 226. These messages may be wirelessly transmitted to remote devices, such as cellular base stations. Thus, with reference to FIG. 1, DTMF signaling messages 222 may be sent to transceiver 114 for wireless transmission. The embodiments, however, are not limited to this context.

After being transmitted wirelessly, DTMF signaling messages 222 may be received by a remote network entity (e.g., a mobile switching center (MSC)) and processed accordingly. For instance, the remote network entity may regenerate corresponding DTMF digits and send them across a public switched telephone network (PSTN). The embodiments, however, are not limited to this example.

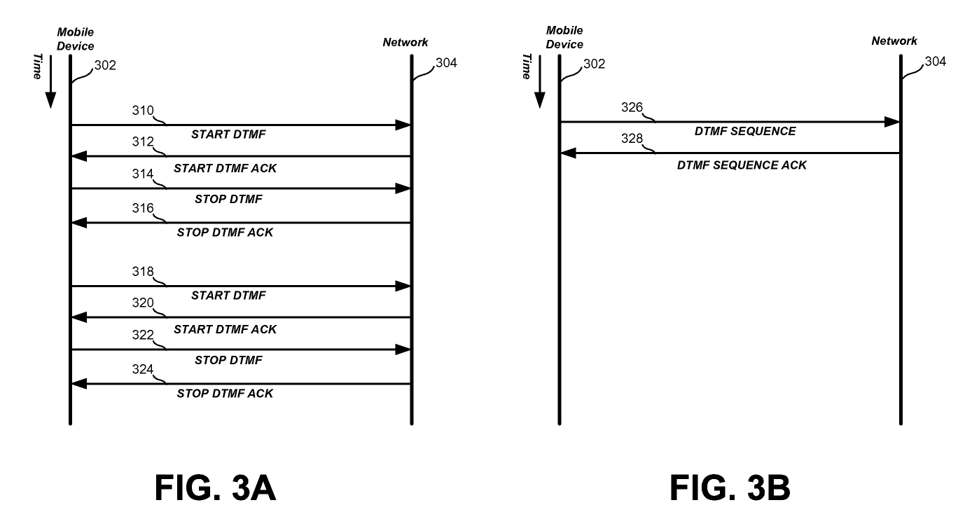

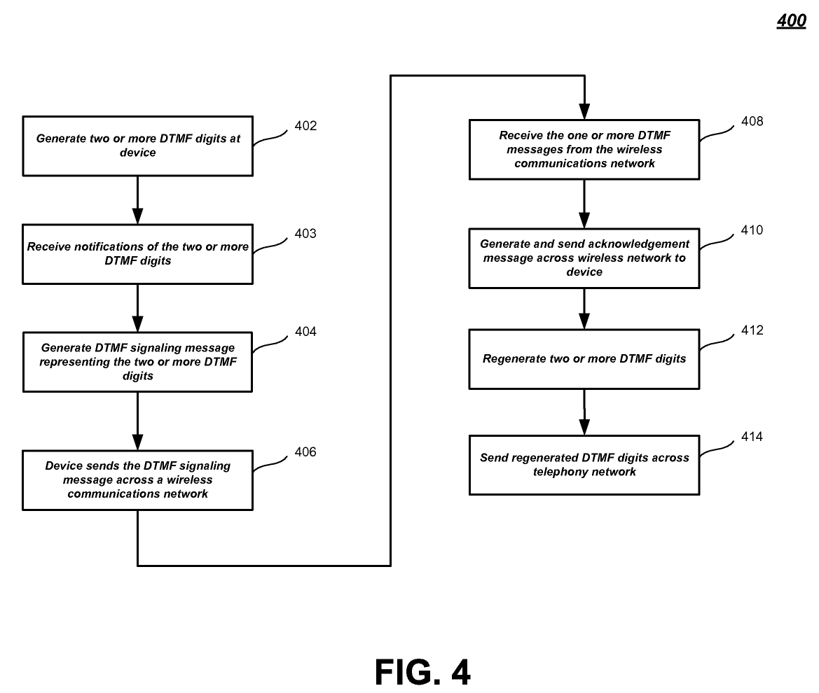

In addition, such remote network entities may send messages that acknowledge reception of DTMF signaling messages 222. Accordingly, FIG. 2 shows message processing module 206 receiving acknowledgement messages 224. These messages are wirelessly transmitted by remote devices (e.g., cellular base stations) to indicate that a corresponding DTMF signaling message 222 was received. Thus, referring again to FIG. 1, message processing module 206 may receive acknowledgement messages 224 from transceiver 114. The embodiments, however, are not limited to this context. Further details regarding the the content and exchange of signaling messages 222 and 224 are provided below with reference to FIGS. 3A-3B and FIG. 4.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

FIGS. 3A and 3B are diagrams showing exemplary message exchanges. In particular, these diagrams show the exchange of messages between a mobile device (or mobile subscriber) 302 and a network 304. In the context of FIG. 1, mobile device 302 may include apparatus 100. Thus, mobile device 302 may communicate across wireless (e.g., cellular) links. Network 304 may include a wireless cellular network (e.g., a GSM and/or a UMTS network). Accordingly, network 304 may include various entities, such as base stations, base station controllers, mobile switching centers, and so forth.

As described above, each DTMF signal generates its own set of messages in conventional GSM and UMTS networks. For example, FIG. 3A shows four messages being exchanged for a first DTMF digit and four messages being exchanged for a second DTMF digit. These messages for the first digit include a start DTMF message 310 sent by mobile device 302, a start DTMF ACK message 312 sent by network 304, a stop DTMF message 314 sent by mobile device 302, and a stop DTMF ACK message 316 sent by network 304. Similarly, FIG. 3A shows messages 318, 320, 322, and 324 being transferred for a second DTMF digit.

Thus, FIG. 3A shows mobile device 302 sending two messages (i.e., a start DTMF message and a stop DTMF message) to network 304 for each DTMF digit. Transmission of a start DTMF message may occur at a time corresponding to when the DTMF digit is initiated on mobile device 302 (e.g., when a user presses the digit's corresponding key). Conversely, transmission of a stop DTMF message may occur at a time corresponding to when the DTMF digit is finished on mobile device 302 (e.g., when a user releases the digit's corresponding key).

The DTMF signaling approach of FIG. 3A causes significant over-the-air latency. For example, in certain networks, the ACK message for each start DTMF or stop DTMF message is typically returned after approximately 300 milliseconds. Thus, the transfer of each single DTMF digit or symbol may require approximately 600 milliseconds. These latencies are significantly longer than the latencies experienced in traditional wired telephony systems and voice over IP (VOIP) systems. Moreover, such latencies may contribute to a poor user experience.

In contrast, embodiments combine multiple DTMF digits into single message sets. For instance, FIG. 3B shows an exemplary transfer of messages in which a sequence of one or more DTMF digits (e.g., the two DTMF digits of FIG. 3A) is handled by a single set of messages. For example, these messages include a DTMF sequence message 326, and a DTMF sequence ACK message 328. These messages may be formatted messages containing multiple data fields.

DTMF sequence message 326 is also referred to as a “burst DTMF” message because it may include information for one or more DTMF digits generated by device 302. With reference to FIG. 1, these digit(s) may be entered by a user through user interface 106. The embodiments, however, are not limited to this form of DTMF digit generation.

DTMF sequence message 326 may include one or more fields for each of these DTMF digit(s). These fields may be arranged to indicate the sequence in which its DTMF digits have been generated by device 302.

For example, DTMF sequence message 326 may include, for each of its DTMF digit(s), a digit value field, a digit start time field and a digit stop time field. The embodiments, however, are not limited to these exemplary fields. The digit value field indicates the value of the corresponding DTMF digit, the digit start time field indicates when the corresponding digit was initiated by device 302, and the digit stop time field indicates when the corresponding digit was concluded by device 302.

As an alternative (or an addition) to having a digit start time field and a digit stop time field for each of its DTMF digits, DTMF sequence message 326 may include a digit duration field that indicates the duration at which the corresponding digit was entered.

In embodiments, fields such as the digit start time field, the digit stop time field, and/or the digit duration field may be set to contain actual start, stop, and/or duration times. However, in embodiments, these fields may be automatically set to contain certain start times, stop times, and/or duration times. Such times may be based on various default settings of mobile device 302.

In addition, DTMF sequence message 326 may include a field (e.g., a header) that identifies the message as a burst DTMF message. Also, DTMF message 326 may include a field indicating a unique identifier (such as a serial number) so that it may be distinguished from other burst DTMF messages.

FIG. 3B shows that network 304 sends DTMF sequence ACK message 328 to mobile device 302. This message acknowledges receipt of DTMF sequence message 326 by network 304. DTMF sequence ACK message 328 may be generated by various entities within network 304, such as a mobile switching center or a base station controller. The embodiments, however, are not limited to these examples.

DTMF sequence ACK message 328 is a message that is specifically used for responding to DTMF sequence message 326. Thus, DTMF sequence ACK message 328 may have a specific identifier (e.g., a header) that identifies it as an acknowledgement message for a received burst DTMF message. Moreover, DTMF sequence ACK message 328 may include one or more fields indicating that it corresponds to a particular burst DTMF message (i.e., DTMF sequence message 326). Such field(s) may include the unique identifier (e.g., serial number) of DTMF sequence message 326.

As described above, existing wireless networks, such as cdma2000 systems, employ signaling messages that convey multiple DTMF digits. Conversely, such techniques are not currently employed in GSM and/or UMTS networks.

Moreover, cdma2000 systems employ layer 2 (L2) signaling messages to acknowledge DTMF messages sent by mobile devices. Layer 2 signaling messages are messages that provide for the correct transmission and reception of signaling messages. However, unlike layer 3 (L3) signaling, these messages do not concern protocol semantics and timing. Thus, these layer 2 acknowledgements are not particular to DTMF signaling and merely indicate reception of messages sent by the mobile device without regard for the type of signaling messages they are acknowledging.

The techniques described herein employ acknowledgment (ACK) messages that are sent from networks to mobile devices to confirm the receipt of burst DTMF messages by the network. As described above, embodiments employ DTMF-specific acknowledgement messages. More particularly, such DTMF-specific ACK messages (such as DTMF sequence ACK message 328) are sent only in response to burst DTMF messages (such as DTMF sequence message 326). Accordingly, such ACK messages are layer 3 (L3) or greater signaling messages because they concern communication protocol semantics and timing. Thus, cdma2000 networks do not employ DTMF-specific acknowledgment messages, as described herein.

FIG. 4 illustrates one embodiment of a logic flow. In particular, FIG. 4 illustrates a logic flow 400, which may be representative of the operations executed by one or more embodiments described herein. As shown in FIG. 4, two or more DTMF digits are generated by a device at a block 402. These digits may be generated through user interaction with the device. Alternatively, these digits may be generated automatically, for example, by a user application.

FIG. 4 further shows that notifications of the two or more DTMF digits are received at a block 403. In the context of FIG. 2, this may comprise burst DTMF detection module 202 receiving multiple DTMF digit notifications 220.

Various timing requirements may be met by the reception of these notifications and/or the generation of these digits. For instance, the notifications may be received within a predetermined time interval. Alternatively, the DTMF digits may be generated within a predetermined time interval. As another alternative, the elapsed times between all pairings of consecutive notifications received at block 403 may be less than a predetermined time duration. As yet a further alternative, the elapsed times between all pairings of consecutive DTMF digits entered at block 402 may be less than a predetermined time duration. The embodiments, however, are not limited to these exemplary timing requirements.

Based on these signals, a block 404 generates a DTMF signaling message. This message represents the two or more DTMF digits, as these digits satisfy one or more timing requirements, such as one or more of the requirements described above. This DTMF signaling message may be a burst DTMF message, as described above with reference to FIG. 3B. In the context of FIG. 2, this DTMF signaling message may be generated by message processing module 206 as a DTMF message 222.

As indicated by a block 406, the device sends the DTMF signaling message across a wireless communications network, such as a GSM and/or UMTS network. Referring to FIG. 1, this message may be wirelessly transmitted by transceiver 114 in conjunction with antenna 110.

FIG. 4 further shows blocks 408-414. One or more of these blocks may be implemented at a network entity, such as a mobile switching center (MSC). The embodiments, however, are not limited to such implementations.

At a block 408, the one or more DTMF messages are received from the wireless communications network. Based on these messages, the network entity may, at a block 410, generate a corresponding acknowledgement (ACK) message (such as DTMF sequence ACK message 328 of FIG. 3B). This generated ACK message is then sent across the wireless network to the device.

Based on the DTMF signaling message received at block 408, the corresponding two or more digits are regenerated by the network at a block 412. In particular, these digits are the digits generated by the device at block 402. As indicated by a block 414, these regenerated digits may then be sent (e.g., as conventional DTMF tone signals) across a telephony network. Such a network may be public switched telephony network (PSTN) or other network (wired or wireless). These digits may be sent to a terminal device coupled to the telephony network. Examples of such terminal devices include handsets and automated menu systems. The embodiments, however, are not limited to these examples.

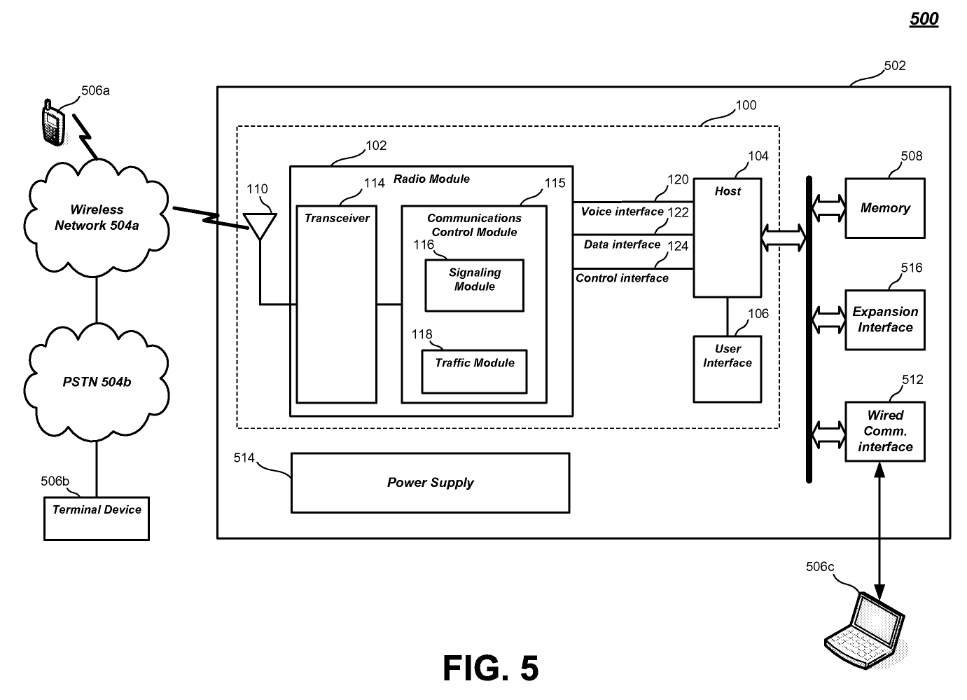

FIG. 5 illustrates an embodiment of a system 500. This system may be suitable for use with one or more embodiments described herein, such as apparatus 100, implementation 200, logic flow 400, and so forth. Accordingly, system 500 may engage in wireless communications across various link types, such as the ones described herein. In addition, system 500 may perform various user applications.

As shown in FIG. 5, system 500 may include a device 502 (e.g., a wireless handset, smartphone, etc.), multiple communications networks 504, and one or more remote devices 506. FIG. 5 shows that device 502 may include the elements of FIG. 1. However, device 502 may include the elements of other embodiments.

Also, device 502 may include a memory 508, a wired communications interface 512, a power supply (e.g., a battery) 514, and an expansion interface 516. These elements may be implemented in hardware, software, firmware, or any combination thereof.

Power supply 514 provides operational power to elements of device 502. Accordingly, power supply 514 may include a battery. Such a battery may be rechargeable and/or removable. Alternatively or additionally, power supply 514 may include an interface to an external power source, such as an alternating current (AC) source. However, the embodiments are not limited to these examples.

Memory 508 may store information in the form of data. For instance, memory 508 may contain application documents, e-mails, sound files, and/or images in either encoded or unencoded formats.

Alternatively or additionally, memory 508 may store control logic, instructions, and/or software components. These software components include instructions that can be executed by one or more processors. Such instructions may provide functionality of one or more elements. Exemplary elements include host 106, one or more components within radio module 102, and/or user interface 106.

Memory 508 may be implemented using any machine-readable or computer-readable media capable of storing data, including both volatile and non-volatile memory. For example, memory 508 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 508 may be included in other elements of system 500. For instance, some or all of memory 508 may be included on a same integrated circuit or chip with elements of apparatus 100 and/or apparatus 500. Alternatively some portion or all of memory 508 may be disposed on an integrated circuit or other medium, for example a hard disk drive, which is external. The embodiments are not limited in this context.

Wired communications interface 512 provides for the exchange of information with a device 506c (e.g., a proximate device), such as a personal computer. This exchange of information may be across one or more wired connections. Examples of such connections include USB interfaces, parallel interfaces, and/or serial interfaces. In addition, interface 512 may provide for such exchanges across wireless connections(s). An infrared interface is an example of such a connection. The information exchanged with such proximate devices, may include e-mail, calendar entries, contact information, as well as other information associated with personal information management applications. In addition, such information may include various application files, and content (e.g., audio, image, and/or video).

Wired communications interface 512 may include various components, such as a transceiver and control logic to perform operations according to one or more communications protocols. In addition, wired communications interface 512 may include input/output (I/O) adapters, physical connectors to connect the I/O adapter with a corresponding communications medium.

Expansion interface 516 may be in the form of an expansion slot, such as a secure digital (SD) slot. Accordingly, expansion interface 516 may accept memory, external radios (e.g., global positioning system (GPS), Bluetooth, WiFi radios, etc.), content, hard drives, and so forth. The embodiments, however, are not limited to SD slots. Other expansion interface or slot technology may include memory stick, compact flash (CF), as well as others.

FIG. 5 shows that memory 508, wired communications interface 512, and expansion interface 516 are coupled to host 102 by an interconnection medium 5 10. Interconnection medium 510 provides for couplings among elements, such as radio module 102, host 104, and user interface 106. Thus, interconnection medium 510 may include, for example, one or more bus interfaces. Exemplary interfaces include Universal Serial Bus (USB) interfaces, as well as various computer system bus interfaces. Additionally or alternatively, interconnection medium 510 may include one or more point-to-point connections (e.g., parallel interfaces, serial interfaces, etc.) between various element pairings. Such connections may comprise one or more signal lines. Moreover, interconnection medium 510 may include non-physical aspects. For instance, such interconnectivity may be implemented through messages passed between processes or software modules.

FIG. 5 shows that device 502 may communicate across wireless network 504a. In particular, FIG. 5 shows communications across network 504a being handled by radio module 102. Wireless network 504a may be a cellular network, such as a GSM and/or UMTS network. As shown in FIG. 5, wireless network 504a may be coupled to public switched telephone network (PSTN) 504b.

Such wireless communications allow device 502 to communicate with various remote devices. For instance, FIG. 5 shows device 502 engaging in wireless communications (e.g., telephony or messaging) with a mobile device 506a. In addition, FIG. 5 shows device 502 engaging in communications with a wired terminal device 506b that is coupled to PSTN 504b. Terminal device 506b may be a telephone handset. Alternatively, terminal device 506b may be an automated menu system that is navigated through DTMF signaling.

To provide such features, wireless network 504a may include a controller (e.g., a mobile switching center (MSC)) that receives DTMF messages, as described herein. The controller may be implemented in hardware, software, firmware, or any combination thereof. Upon receipt of such messages, the controller may generate DTMF signals that it sends across PSTN 504b. For example, such DTMF signals may be sent to terminal device 506b. The embodiments, however, are not limited to this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Although the above description was made in the context of GSM and UMTS systems, the techniques described herein may be employed with other wireless telecommunications systems, such cellular radiotelephone systems compliant with the Third-Generation Partnership Project (3GPP), 3GPP2, and so forth. However, the embodiments are not limited to these examples. For example, various 4G systems may be employed.

Further, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a dual-tone multi-frequency (DTMF) messaging module to generate a DTMF message, the DTMF message representing two or more DTMF digits; and
a transceiver to send the DTMF message across a wireless communications network, and to receive an acknowledgement of the DTMF message from the wireless communications network;
wherein the DTMF acknowledgement is a DTMF-specific signaling message.

2. The apparatus of claim 1, wherein the DTMF acknowledgment is a layer 3 signaling message.

3. The apparatus of claim 1, wherein the wireless network is a Global System for Mobile communications (GSM) network or a Universal Mobile Telecommunications System (UMTS) network.

4. The apparatus of claim 1, wherein the wireless network is a time division multiple access (TDMA) network.

5. The apparatus of claim 1, further comprising a user interface to generate the two or more DTMF signals in response to a user selection of the two or more DTMF digits.

6. The apparatus of claim 5, wherein the two or more DTMF signals are generated within a predetermined time interval.

7. A system, comprising:
a dual-tone multi-frequency (DTMF) messaging module to generate a DTMF message, the DTMF message representing to two or more DTMF digits;
a transceiver to send the DTMF message across a wireless communications network, and to receive an acknowledgement of the DTMF message from the wireless communications network; and
a network module to receive the DTMF message, and to regenerate the two or more DTMF digits;
wherein the acknowledgement is a DTMF-specific signaling message.

8. The system of claim 7, wherein the network module is to send the two or more regenerated digits across a telephony network.

9. The system of claim 7, wherein the telephony network is a public switched telephone network (PSTN).

10. The system of claim 7, wherein the network module is a mobile switching center (MSC).

11. The system of claim 7, wherein the acknowledgment is a layer 3 signaling message.

12. The system of claim 7, wherein the wireless network is a Global System for Mobile communications (GSM) network or a Universal Mobile Telecommunications System (UMTS) network.

13. A method, comprising:
receiving one or more notifications, the one or more notifications indicating the generation of two or more dual-tone multi-frequency (DTMF) digits;
generating a DTMF message, the DTMF message representing to the two or more DTMF signals;
sending the DTMF message across a wireless communications network; and
receiving an acknowledgement of the DTMF message from the wireless communications network, wherein the acknowledgement is a DTMF-specific signaling message.

14. The method of claim 13, wherein the acknowledgement is a layer 3 signaling message.

15. The method of claim 13, wherein the two or more DTMF digits are generated within a predetermined time interval.

16. The method of claim 13, further comprising generating the two or more DTMF digits at a user interface in response to a user selection of the two or more DTMF digits.

17. The method of claim 13, further comprising:
receiving the DTMF message from the wireless communications network; and
regenerating the two or more DTMF digits; and.
sending the two or more regenerated DTMF digits across a telephony network.

18. An article comprising a machine-readable storage medium containing instructions that if executed enable a system to:
receive one or more notifications, the one or more notifications indicating the generation of two or more dual-tone multi-frequency (DTMF) digits;
generate a DTMF message, the DTMF message representing to the two or more DTMF signals;
send the DTMF message across a wireless communications network; and
receive an acknowledgement of the DTMF message from the wireless communications network, wherein the acknowledgement is a DTMF-specific signaling message.

19. The article of claim 18, wherein the acknowledgment is a layer 3 signaling message.

20. The article of claim 18, wherein the wireless communications network is a Global System for Mobile communications (GSM) network or a Universal Mobile Telecommunications System (UMTS) network.
